(19) United States
(12) Patent Application Publication
(10) Pub. No.: US 2008/0296534 A1
(43) Pub. Date: Dec. 4, 2008

(54) Core-Alloyed Shell Semiconductor Nanocrystals

(75) Inventors: Efrat Lifshitz, Haifa (IL); Ariel Kigel, Haifa (IL); Maye Brumer-Gilary, Nesher (IL); Aldona Sashchiuk, Nazareth-Illit (IL); Lilac Amirav, Hod-Hasharon (IL)

Correspondence Address: BROWDY AND NEIMARK, P.L.L.C.;624 NINTH STREET, NW, SUITE 300, WASHINGTON, DC, 20001-5303, US

(73) Assignee: TECHNION RESEARCH AND DEVELOPMENT FOUNDATION LTD., Haifa (IL)

(21) Appl. No.: 11/662,272

(22) PCT Filed: Sep. 8, 2005
(86) PCT No.: PCT/IL2005/000952

§ 371 Date: Oct. 31, 2007

Related U.S. Application Data
(60) Provisional application No. 60/608,108, filed on Sep. 9, 2004.

(51) Int. Cl. C09K 11/56; C09K 11/08

(52) U.S. Cl. 252/301.36

(57) ABSTRACT

The invention relates to a core-alloyed shell semiconductor nanocrystal comprising: (i) a core of a semiconductor material having a selected band gap energy; (ii) a core-overcoating shell consisting of one or more layers comprised of an alloy of the said semiconductor of (i) and a second semiconductor; (iii) and an outer organic ligand layer, provided that the core semiconductor material is not HgTe. Preferably, the core semiconductor material is PbSe and the alloy shell semiconductor material has the PbSexS1-x structure.

### FIELD OF THE INVENTION

The present invention relates to semiconductor nanocrystals and, in particular, to such nanocrystals comprising a semiconductor core surrounded by a shell of a semiconductor alloy and an outer organic ligand layer.

Abbreviations: EDAX: energy dispersion analytical X-ray; FWHM: full width at half maximum; HR-TEM: high resolution TEM; ML: monolayer(s); NC(s): nanocrystal(s); OA: oleic acid; Pb-ac: lead(II) acetate trihydrate; PhEt: phenyl ether; PL: photoluminescence; PMMA: polymethylmethacrylate; SAED: selected area electron diffraction; TEM: transmission electron microscopy; TOP: trioctylphosphine

### BACKGROUND OF THE INVENTION

Semiconductor nanocrystals (NCs) exhibit size dependent electronic properties due to a quantum confinement effect. The IV-VI (e.g., PbSe, PbS) NCs are a focus of special interest due to their unique intrinsic properties (Santoni et al., 1992). Bulk PbSe and PbS materials have a cubic (rock salt) crystal structure and a narrow direct band gap (0.28-0.41 eV at 300 K) at the L point of the Brillouin zone. The high dielectric constant (∈_{∝}=18.0-24.0) and the small electron and hole effective mass (<0.1 m*) create an exciton with a relatively large effective Bohr radius (a_{B(PbSe)}=46 nm), eight times larger than that of CdSe. New inter-band optical studies of colloidal PbSe NCs exhibit well-defined band-edge excitonic transitions tuning between 1.0-0.5 eV, small Stokes shift, and sub-nsec lifetime (Andreev et al., 1999; Du et al., 2002; Wehrenberg et al., 2002).

Recently, an amplified spontaneous emission was demonstrated (Schaller et al., 2003) from PbSe NCs with gain parameters similar to those observed in CdSe NCs (Klimov et al., 2002). These findings indicate the feasibility of using the PbSe and PbS NCs in telecommunication (Colvin et al., 1994), eye-safe lasers, (Schaller et al., 2003; Sirota et al., 2004) and biological markers (Dahan et al., 2001; Murphy et al., 1997).

Various colloidal syntheses have been developed in the last couple of years, producing PbSe NCs with size monodispersity (<5% size distribution), uniform shape, and high crystallinity. Murray et al. (Murray et al., 2001) and Colvin et al. (Yu et al., 2004) synthesized spherical core PbSe NCs, soluble in organic or water solutions, with narrow size-distribution and band-gap tuning at the near IR spectral regime. Lifshitz et al. (Sashchiuk et al., 2002) reported a colloidal procedure for the preparation of spherical PbSe/PbS core-shell NCs, with average size ranging between 2.5-7 nm, using tributylphosphine/trioctylphosphine (TBP/TOP) surfactants. Lifshitz et al. (Lifshitz et al., 2003) also reported a unique colloidal procedure, using alkyl-diamine solvent as a coordinating molecular template, which led to the formation of wires (20 nm×1 μm), rods (20 nm×100 nm), and cubes (100 nm). The use of specific coordinating solvent molecules and adjustment of the temperature and duration of the reaction governed the morphology of those quantum structures. Recently, Lifshitz et al. (Sashchiuk et al., 2003) reported the formation of spherical and wire-like assemblies of core PbSe NCs, preserving the quantum size properties of individual NCs, accompanied by collective conductivity properties of an assembly.

These colloidal procedures varied mainly by the use of surfactants with different molecular lengths and attraction forces to the NCs surface. Alternatively, core-shell structures consisting of NCs covered by an epitaxial layer of another wide-band semiconductor were formed.

Semiconductor nanocrystals that include a core of one or more first semiconductor materials, which may be surrounded by a shell of a second semiconductor material, and are optionally surrounded by a coat of an organic capping agent are disclosed in several US patents granted to Bawendi et al. See, for example, U.S. Pat. No. 6,774,361, U.S. Pat. No. 6,696,299, U.S. Pat. No. 6,617,583, U.S. Pat. No. 6,607,829, U.S. Pat. No. 6,602,671, U.S. Pat. No. 6,576,291, U.S. Pat. No. 6,501,091, U.S. Pat. No. 6,444,143, U.S. Pat. No. 6,426,513, U.S. Pat. No. 6,326,144, U.S. Pat. No. 6,322,901, U.S. Pat. No. 6,319,426, U.S. Pat. No. 6,251,303, and U.S. Pat. No. 6,207,229, all these patents being hereby incorporated by reference in their entirety as if fully disclosed herein. In U.S. Pat. No. 6,602,671, for example, many semiconductors are mentioned in the description and preferable materials for the core are ZnO, ZnS, ZnSe, ZnTe, CdS, CdO, CdSe, CdTe, MgS, MgSe, GaAs, GaN, GaP, GaSb, GaSb, HgO, HgS, HgSe, HgTe, InAs, InN, InP, InSb, AlAs, AlN, AlP, and AlSb, but the examples show specifically semiconductor nanocrystals in which the core is CdSe and the shell is ZnS.

Recently, Fradkin et al. (2003) described the synthesis and magneto-optical properties of HgTe nanocrystals capped with HgxCd1-xTe(s) alloyed shells.

### SUMMARY OF THE INVENTION

The present invention relates to a core-alloyed shell semiconductor nanocrystal comprising: (i) a core of a semiconductor material having a selected band gap energy; (ii) a core-overcoating shell consisting of one or more layers of an alloy of said semiconductor of (i) and a second semiconductor; (iii) and an outer organic ligand layer, provided that the core semiconductor material is not HgTe.

In preferred embodiments, the semiconductor core material is a lead chalcogenide, more preferably PbSe, and the semiconductor alloy is composed of said lead chalcogenide and another chalcogen such as S or Te. Preferably, the alloy is PbSeₓS₁₋ₓ.

### BRIEF DESCRIPTION OF THE FIGURES

FIGS. 1A-1F depict HR-TEM images (Bar scale=5.0 nm) of: (A) a 4.8 nm core PbSe NC; (B) a 6.1 nm PbSe/PbS core-shell NC with 4.8 nm core; (C) a 6.1 nm PbSe/PbSeₓS₁₋ₓ core-alloyed shell NC with Pb:Se:S molar ratio similar to the sample in (B); (D) Fast Fourier transform of the image in (B); (E) A 7.3 nm PbSe/PbS core-shell NC with 4.8 nm core; (F) a 7.5 nm PbSe/PbSeₓS₁₋ₓ core-alloyed shell NC with Pb:Se:S molar ratio similar to the sample in (C). A two-injection process was used in B and E, and a single-injection process was used in C and F.

FIG. 2 is a graph showing the absorption spectra of core PbSe NCs (capped with OA and TOP surfactants) with various core diameters.

FIG. 3 is a graph showing absorbance (dashed lines) and PL (solid lines) spectra, recorded at room temperature, of core PbSe NCs (bottom curves); PbSe/PbS core-shell NCs with nML (n=1, 2, 3) shell thickness, prepared by a two-injection process (three middle curves); and PbSe/PbSeₓS₁₋ₓ core-alloyed shell NCs with Pb:Se:S molar ratio similar to the PbSe/PbS core-shell (with nML) NCs, prepared by a single-injection process (two top curves).

FIG. 4 shows a plot of 1S-exciton absorption energy versus growth time of aliquots of core PbSe NCs (spheres), corresponding core-shell NCs with Pb:S mole ratio equivalent to a 1ML of PbS (triangles) and core-shell NCs with Pb:S ratio of 2MLs of PbS (squares). The samples were prepared by a single-injection process. The solution concentrations of the indicated samples were identical.

FIG. 5 shows a plot of the normalized absorption intensity versus the 1S-exciton energy of core PbSe NCs (spheres), corresponding core-shell NCs with Pb:S mole ratio equivalent to a 1ML of PbS (triangles) and core-shell NCs with Pb:S mole ratio equivalent to 2MLs of PbS (squares). The samples were prepared by a single-injection process. The solution concentrations of the indicated samples were identical.

### DETAILED DESCRIPTION OF THE INVENTION

In one aspect, the present invention provides a core-alloyed shell semiconductor nanocrystal comprising: (i) a core of a semiconductor material having a selected band gap energy; (ii) a core-overcoating shell consisting of one or more layers comprised of an alloy of said semiconductor of (i) and a second semiconductor; (iii) and an outer organic ligand layer, provided that the core semiconductor material is not HgTe.

As used herein, “a core-alloyed shell semiconductor nanocrystal” includes, for example, inorganic crystallites between about 3 nm and about 1000 nm in diameter, preferably between about 3 nm and about 50 nm, more preferably between about 3 nm to about 20 nm, still more preferably between about 3 nm to about 20 nm, that comprises a core of a first semiconductor material and which is surrounded by a shell of a semiconductor material that is an alloy composed of the core first semiconductor material and a second semiconductor material.

The core can be a semiconductor material including, but not limited to, those of the group II-VI (ZnS, ZnSe, ZnTe, CdS, CdSe, CdTe, HgS, HgSe, MgTe) and III-V (GaN, GaP, GaAs, GaSb, InN, InP, InAs, InSb, AlAs (vis), AlP (uv), AlSb (vis), AlN (uv)) and IV-VI (PbS, PbSe, PbTe) materials.

The core semiconductor material is selected according to its band gap energy. The selection of the semiconductor material composing the core is made according to the desired application, which requires a specific band gap.

Thus, in one embodiment, the band gap energy of the core semiconductor material is in the infra-red energy range. Examples of such semiconductor materials are PbS, PbSe, PbTe, InN, InP, InAs, InSb, HgS, HgSe, or GaSb. In a more preferred embodiment of the invention, the core semiconductor material is PbSe.

In another embodiment, the band gap energy of the core semiconductor material is in the visible energy range. Examples of such semiconductor materials are CdS, CdSe, CdTe, ZnSe, ZnTe, AlAs, AlP, AlSb, AlN, GaP or GaAs.

In a further embodiment, the band gap energy of the core semiconductor material is in the ultraviolet energy range. Examples of such semiconductor materials are CdS, ZnS or GaN.

The shell material surrounding the core is a semiconductor alloy material composed of the core semiconductor material and a second semiconductor material.

In one embodiment, the alloy shell material has a bandgap greater than the core bandgap and can be used as an optically capping to the core for an improved quantum yield. In another embodiment, the alloy shell material has a bandgap smaller than the core bandgap and can be used for the cases where the alloyed shell is in the focus of interest.

The atomic spacing of the alloy shell should be close to that of the core material in order to prevent crystallographic mismatch that would result in the formation of carriers trapping sites. However, the gradual change of the alloy shell atomic spacing should relax the stick demand and offer the ability to use a variety of semiconductors for the alloyed shell, including combinations of core/shell that were not seen previously. The atomic spacing should be identical to that of the core material or differ from it by up to 5%. The crystallographic structure should be identical to that of the core material.

In one embodiment, the present invention provides a core-alloyed shell semiconductor nanocrystal, wherein the core has the structure of AB or AC; the semiconductor shell comprises an alloy of the ABₓC₁₋ₓ structure, wherein A is selected from the group consisting of Cd, Zn, Hg, In, Ga, and Pb; B and C are selected from the group consisting of N, P, As, S, Se and Te; x is the mole fraction of B and 1-x is the mole fraction of C, with x gradually changing from 1 to zero. In one preferred embodiment, A is Pb, B is Se and C is S and the invention provides a core-alloyed shell semiconductor nanocrystal wherein the core semiconductor material is PbSe and the alloy shell semiconductor material has the PbSeₓS₁₋ₓ structure.

In another embodiment, the present invention provides a core-alloyed shell semiconductor nanocrystal wherein the core has the structure of DF or EF; the semiconductor shell comprises an alloy of the DₓE₁₋ₓF structure, wherein D and E are selected from the group consisting of Cd, Zn, Hg, In, Ga, and Pb; F is selected from the group consisting of N, P, As, S, Se and Te; x is the mole fraction of D and 1-x is the mole fraction of E, with x gradually changing from 1 to zero, but excluding the core-alloyed shell semiconductor nanocrystal wherein the core has the structure of HgTe and the semiconductor shell comprises an alloy of the HgₓCd₁₋ₓTe structure. In one embodiment, D is Cd, E is Zn and F is S and the invention provides a core-alloyed shell semiconductor nanocrystal wherein the core semiconductor material is CdS and the alloy shell semiconductor material has the CdₓZn₁₋ₓS structure.

The core-alloyed shell semiconductor nanocrystals of the invention are further capped by an outer organic ligand layer. The organic capping agent may be selected from a large number of materials, but it should have an affinity for the semiconductor nanocrystal surface. In general, the capping agent can be an isolated organic molecule, a polymer (or a monomer for a polymerization reaction), or an inorganic complex. The coat may be used to convey solubility, e.g., the ability to disperse a coated semiconductor nanocrystal homogeneously into a chosen solvent, functionality, binding properties, or the like. In addition, the coat can be used to tailor the optical properties of the semiconductor nanocrystal. The organic ligand layer may be an organic molecule that has groups that bind to the nanocrystal surface layer. If the nanocrystals are used for identification purposes, the organic molecule will also have groups that bind to substances or materials.

Stabilization agents must be present during the nanocrystals growth to prevent aggregation and precipitation of the nanocrystals. When the stabilizing molecules are attached to the nanocrystal surface as a monolayer though covalent, dative (coordination), or ionic bonds, they are referred to as capping groups or ligands. These ligands serve to mediate nanocrystal growth, sterically stabilize nanocrystals in solution, and passivate surface electronic states. Synthetic organic techniques allow the tail and head groups to be independently tailored through well established chemical substitutions. Examples of such organic ligands include, without being limited to, alkyl amines and ammonium salts thereof; aryl amines and ammonium salts thereof; alkyl phosphonium salts; aryl phosphonium salts; alkyl organic acids and salts thereof; aryl organic acids and salts thereof; aliphatic alcohols; aryl alcohols; alkylphosphines, alkylphosphine oxides, arylphosphines, arylphosphine oxides, and pyridine. In preferred embodiments of the invention, the organic ligand is a trialkylphosphine such as trioctylphosphine (TOP), or a trialkylphosphine oxide such as trioctylphosphine oxide (TOPO).

The semiconductor nanocrystals of the invention are prepared in a coordinating solvent, such as trioctylphosphine oxide (TOPO) or trioctyl phosphine (TOP), resulting in the formation of a passivating organic layer on the nanocrystal surface comprised of the organic solvent. The passivated semiconductor nanocrystals are readily soluble/dispersible in organic solvents, such as toluene, chloroform and hexane. In addition, the functional moieties of the capping agent may be readily displaced or modified to provide an outer coating that renders the semiconductor nanocrystals suitable for several uses.

In one embodiment of the invention, the alloyed shell of the semiconductor nanocrystal exhibits gradual change of the crystallographic lattice spacing from the crystallographic lattice spacing of the core to that of the most outer layer. The shell is a ternary alloy and as such its semiconducting and structural properties, such as the lattice parameter, the energy gap, etc., can be varied in a controlled fashion by varying the composition. The composition of the alloy can be of a ternary alloy as defined above, i.e., ABₓC₁₋ₓ or DₓE₁₋ₓF, with x gradually changing from 1 to zero. Thus, for example, in the case of the alloyed shell PbSeₓS₁₋ₓ, the composition and hence the material properties will gradually change from those of PbSe to those of PbS. The composition change follows along the nanocrystal radius, R, where the alloyed shell composition is similar to that of the core for the lower values of R and x decreases from one to its minimum value, preferably zero, as R increases. The crystallographic lattice spacing gradual change prevents interface defects between the core and the shell. Such defects can serve as trap sites for charge carriers and damage the nanocrystal luminescence.

In another embodiment of the invention, the alloyed shell of the semiconductor nanocrystal exhibits gradual change of the dielectric constant, thus improving the quantum yield for luminescence, by decreasing the probability of competing, non-radiative events associated with the trapping of carriers (electrons or holes) in an abrupt core-shell interface.

The selection of the composition as well as the size of the semiconductor nanocrystal affects the characteristic spectral emission wavelength of the semiconductor nanocrystal. Thus, a particular composition of a semiconductor nanocrystal as described above will be selected based upon the spectral region being monitored. For example, semiconductor nanocrystals that emit energy in the visible range include, but are not limited to CdS, CdSe, CdTe, ZnSe, ZnTe, GaP, and GaAs. Semiconductor nanocrystals that emit energy in the near IR range include, but are not limited to, InP, InAs, InSb, PbS, and PbSe. Finally, semiconductor nanocrystals that emit energy in the blue to near-ultraviolet include, but are not limited to CdS, ZnS and GaN. For any particular composition selected for the semiconductor nanocrystals of the invention, it is possible to tune the emission to a desired wavelength by controlling the size of the particular composition of the semiconductor nanocrystal. In preferred embodiments, monodispersed nanocrystals are required because of the strong influence of the nanocrystals size on their properties. In particular, preparation of monodispersed samples enables systematic control of the structural, electronic, and optical properties of the semiconductors core-alloyed shell nanocrystals. As used herein, “monodispersed nanocrystals” means a colloidal system in which the suspended particles have substantially identical size and shape with standard deviations of less than 10% root-mean-square (rms) in diameter, and preferably less than 5%. Further narrowing of the sample monodispersity can be done by optical means, through selective excitation of only a fraction of the sample. The more preferable standard deviation of 5% corresponds to ±one lattice constant throughout the 1-15 nm size range.

In preferred embodiments, the core-alloyed shell semiconductor nanocrystals of the invention exhibit photoluminescence having quantum yields within the range of 20% to 100%, preferably greater than 40-50%, more preferably greater than 60-70%, most preferably equal to or greater than 80%.

Nanocrystalline materials can be tailored by a judicious control of particle composition, size and surface. This can be achieved by a number of chemical strategies, e.g. fast injection of precursors in coordinating solvents.

The present invention further provides a colloidal synthetic single-injection process for the preparation of a core-alloyed shell semiconductor nanocrystal of the invention, said process comprising the simultaneous injection of stoichiometric amounts of the semiconductor core and shell constituents into a mother solution, at elevated temperatures, under inert conditions. At the beginning, a fast reaction of the precursors of the semiconductor core material occurs leading to a fast nucleation of the core material, followed by a slower deposition of the shell alloy with a gradual composition. This single-injection procedure results in an improved control over shape, size, size distribution and purification of the nanocrystals, since it requires less human involvement.

For example, for the preparation of the nanocrystals of the invention wherein the semiconductor material of the core is AB or AC, the semiconductor shell comprises an alloy of the ABₓC₁₋ₓ structure, wherein A is selected from the group consisting of Cd, Zn, Hg, In, Ga, and Pb, B and C are selected from the group consisting of N, P, As, S, Se and Te, x is the mole fraction of B, and 1-x is the mole fraction of C, with x gradually changing from 1 to zero, precursors of AB and AC, are dissolved in a solution of an organic solvent and surfactant and simultaneously injected into a mother solution at high temperature, quenching to room temperature and isolating the nanocrystals.

In one specific embodiment, the preparation of PbSe/PbSeₓS₁₋ₓ core-alloyed shell nanocrystals of the invention is carried out by injecting a mixture of: (i) the precursor lead acetate trihydrate dissolved in a solution of phenyl ether, oleic acid and trioctylphosphine (TOP), and (ii) a chalcogen precursor mixture of Se and S dissolved in TOP, into a pre-heated phenyl ether mother solution, terminating the nanocrystals growth by quenching to room temperature, and isolating the nanocrystals.

The present invention provides a distinctive technique for the growth of PbSe/PbSeₓS₁₋ₓ core-alloyed shell NCs by a single-injection of Pb, Se and S into a pre-heated mother solution. The properties of PbSe/PbSeₓS₁₋ₓ core-alloyed shell NCs, prepared by a single-injection process, are compared with those of PbSe/PbS core-shell NCs, prepared by a two-injection process, using the same precursors and surfactants. As described below, a single-injection process permits the generation of core-alloyed shell structures, when the fast nucleation of PbSe component creates the core constituent, followed by a slower precipitation of a PbS or PbSeₓS₁₋ₓ alloyed shell, with ˜1% crystalline mismatch.

This synthetic procedure supplies high quality lead chalcogenide core-alloyed shell nanocrystals. The constituents, PbSe and PbS semiconductors, show a similar crystallographic rock salt structure with a 1.3% crystallographic mismatch, suitable for the formation of highly ordered core-shell structures. The research investigations compared the influence of the shell composition on the structural and optical properties of the following samples: (a) Core PbSe NCs capped with organic ligands; (b) PbSe/PbS core-shell NCs, prepared by an exchange of the organic ligands with the PbS shell (named herein as two-injection process); (c) PbSe/PbSeₓS₁₋ₓ core-alloyed shell NCs, prepared by a simultaneous injection of the precursors (named herein as a single-injection process). The indicated syntheses utilized Pb, Se and/or S precursors in OA/TOP/PhEt as a stock solution that was injected into a pre-heated PhEt mother solution, either in a single-injection or a two-injection process. A single-injection process permits a fast nucleation of a PbSe core, pursued by a slower precipitation of a PbS or PbSeₓS₁₋ₓ alloyed shell. In addition, the single-injection process generated NCs with 5% size distribution and a luminescence quantum efficiency of 65%, while a two-injection process created NCs with 8% size distribution and a luminescence quantum efficiency of 40%.

The present invention further provides a nanocrystal array of the core-alloyed shell semiconductor nanocrystals of the invention, in ordered or disordered packing, with close proximity of the said nanocrystals, reserving the properties of individual nanocrystals and creating new collective effects. The characteristics of such a nanocrystal array will depend on the array structure (symmetry, the distance between the nanocrystals, the organic ligands used, etc.) and on the nanocrystals that comprise the array.

The semiconductor nanocrystals and nanocrystal arrays of the invention may be useful for many applications, such as light-emitting diodes, lasers, photonic band-gap crystals, ultra fast photonic switches and biomedical tags for fluoroassays, nanosensors and biological imaging. Thus, for example, the core-alloyed shell semiconductor nanocrystals of the invention can be incorporated in a passive Q-switch device, they may be useful in telecommunication, eye-safe lasers in the IR and low power lasers, light emitting diodes, and as biological markers. For use as biological markers, the NCs of the invention should have a very specific suitable type of organic layers as organic capping according to the biological material to be examined. The appealing aspect of the core-alloyed shell nanocrystals of the invention for the biological markers application resides in their excellent photoluminescence quantum yield.

The invention will now be illustrated by the following non-limiting Examples.

### EXAMPLES

### Instrumentation

TEM studies, combined with EDAX and SAED, were carried out on a JEOL 2000FX instrument, operated at 200 kV. HR-TEM images were recorded with a JEOL 3010 instrument operated at 300 kV. The TEM specimens were prepared by injecting small liquid droplets of the solution on a cooper grid (300 mesh) coated with amorphous carbon film and then drying at room temperature. The absorbance spectra were recorded using a UV-VIS-NIR spectrometer JASCO V-570. The PL spectra were obtained by exciting the samples with a Ti:Sapphire laser, while emission was recorded using an Acton monochromator equipped with a cooled Ge detector. All measurements were carried out at room temperature.

### Example 1

### Synthesis of PbSe NCs Cores, Covered with Organic Surfactants

The synthesis of core PbSe NCs followed a modified procedure similar to that given by Murray et al. (Murray et al., 2001), including the preceding stages:

1.1 0.71 gr of lead(II) acetate trihydrate (Pb-ac) [Pb(CH₃COO)₂.3H₂O, GR, Merck] were dissolved in a solution composed of 2 mL PhEt (C₆H₅OC₆H₅, 99%, Aldrich), 1.5 mL OA (CH₃(CH₂)₇CHCH(CH₂)₇COOH, 99.8%, Aldrich) and 8 mL TOP ((C₈H₁₇)₃P, Tech, Aldrich), under standard inert conditions in the glove box, and were inserted into a three-neck flask (flask I);

1.2 10 mL of PhEt were inserted into a three-neck flask (flask II) under the inert conditions of a glove box;

1.3 Both flasks were taken out of the glove box, were placed on a Schlenk line and heated under a vacuum to 100-120° C. for an hour;

1.4 Flask I was cooled to 45° C., while flask II was heated to 180-210° C., both under a fledging of an argon-gas;

1.5 0.155 gr of selenium powder (Se, 99.995%, Aldrich) was dissolved in 2.0 mL TOP, forming a TOP:Se solution, under standard inert conditions of a glove box. Then, 1.7 mL of this solution was injected into flask I on the Schlenk line;

1.6 The content of flask I, containing the reaction precursors, was injected rapidly into the PhEt solution in flask II, reducing its temperature to 100-130° C., leading to the formation of PbSe NCs within the first 15 minutes of the reaction.

The above procedure produced nearly monodispersed NCs with <8% size distribution, with average size between 3-9 nm, controlled by the temperature and by the time duration of the reaction.

### Example 2

### Synthesis of PbSe/PbS Core-Shell NCs by a Two-Injection Process

The preparation of PbSe/PbS core-shell NCs by a two-injection process begins with formation of core PbSe NCs and their isolation from the initial reaction solution, according to the procedure in Example 1 above. The core NCs were re-dissolved in chloroform solution, forming a solution of 50 mg/mL weight concentration. 1.4 mL of TOP was then added to the NCs solution, while the chloroform molecules were removed by distillation under vacuum and heating at 60° C. In parallel, 0.2 gr of a Pb precursor, Pb-ac, was dissolved in a mixture of 2 mL PhEt, 1.5 mL of OA, and 8 mL of TOP, heated to 120° C. for an hour, and then cooled to 45° C. Also, 0.03-0.10 gr of sulfur (S, 99.99+%, Aldrich) was dissolved in 0.3 mL of TOP and was premixed with a PbSe core NCs in a TOP solution. This mixture was injected into the Pb-ac solution. All reagents were then injected into a PhEt mother solution and kept on a Schlenk line at 180° C., causing a reduction in temperature of the mother solution to 120° C. The indicated chemical portions caused the precipitation of 1ML-3 ML of PbS shell over the PbSe core surface within the first 15 minutes of the reaction.

### Example 3

### Synthesis of PbSe/PbSeₓS₁₋ₓ Core-Alloyed Shell NCs by a Single-Injection Process

The preparation of PbSe/PbSeₓS₁₋ₓ core-alloyed shell structures was nearly identical to that of the core PbSe NCs, described in Example 1, using a single injection of the precursors into a single round flask. However, step 1.5 was altered by the use of an alternative chalcogen precursor solution. A stock solution of Se and S was prepared by mixing 0.15 gr Se dissolved in 1.4 mL TOP, with 0.03-0.10 gr S dissolved in 0.3 mL TOP. The amount of S in the new stock solution corresponded to a stoichiometric amount of 1-3 monolayers of the PbS compound. Thus, the mole ratio of the precursors Pb:Se:S ranged from 1:1:0.5 to 1:1:1.3.

### Example 4

### Purification and Examination of the NCs

Aliquots were drawn periodically from the mother solutions described in Examples 1-3. The NCs growth was terminated by a quenching process to room temperature. They were isolated from the aliquots solution by the addition of methanol, and by centrifugation. The isolated NCs were further purified by dissolving them in chloroform, followed by filtering with 0.02 micron membrane for several times. The purified NCs were examined by structural analyses, absorption and PL spectroscopy.

The colloidal NCs were embedded in a polymer film or dissolved in a glassy solution (2,2,4,4,6,8,8-heptamethylnonane) for the optical measurements. The polymer was prepared by mixing PbSe NCs in chloroform solution with poly-methylmethacrylate (PMMA) [—CH₂C(CH₃)(CO₂CH₃)—]ₙ, analytical grade, Aldrich) polymer solution. The resultant mixture was spread on a quartz substrate and dried to a uniform film over 24 hours.

### Example 5

### Comparison of the Structural Properties of the NC Samples

We compared the influence of the shell composition on the structural properties of the following samples: (a) Core PbSe NCs capped with organic ligands; (b) PbSe/PbS core-shell NCs, prepared by a conventional two-injection process; (c) PbSe/PbSeₓS₁₋ₓ core-alloyed shell NCs, prepared by a single-injection process. The indicated syntheses utilized Pb, Se and/or S precursors in OA/TOP/PhEt as a stock solution that was injected into a pre-heated PhEt mother solution, either in a single-injection or a two-injection process. The single-injection process generated NCs of a 5% size distribution, while the core synthesis and the core-shell synthesis by a two-injection process created NCs of a 8% size distribution.

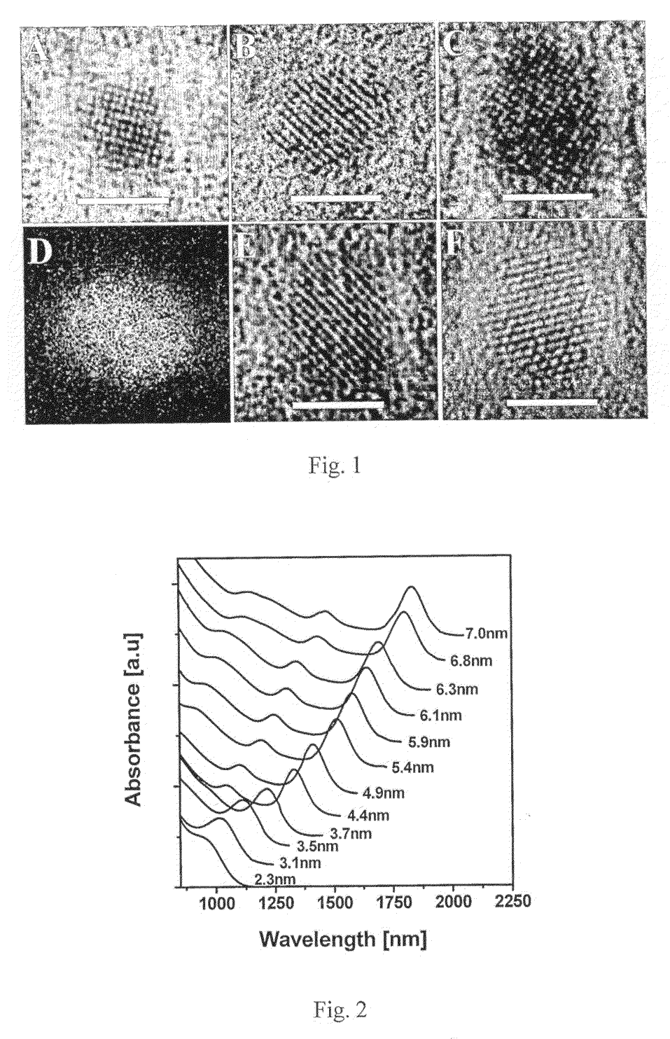

The structural properties of the NCs samples, prepared by a single-injection of Pb, Se, and S precursors (Example 1) were compared with those generated by a two-injection process (Example 2) and with those of the core PbSe NCs, using similar precursors and surfactants (Example 3). The results are shown in FIGS. 1A-1F. FIG. 1A shows the HR-TEM image of core PbSe NCs with a 4.8 nm diameter. HR-TEM images of the corresponding PbSe/PbS core-shell NCs, prepared by a two-injection process, are shown in FIGS. 1B and 1E. The specific images revealed the formation of spherical NCs with a high crystallinity, without a distinct boundary at the core-shell interface, but with an increase in the NCs size by 1.2 nm (1B) or 2.4 nm (1E), consistent with a PbS shell thickness of one and two monolayers (ML). Fast Fourier transform, analogous to a selected area electron diffraction (SAED), of a sample similar to that shown in 1B is represented in FIG. 1D. This confirms the existence of rock salt crystallographic structures for PbSe and PbS without the distinction of separate lattice parameters due to their close crystallographic matching. HR-TEM images of NCs samples, prepared by a single-injection process with stoichiometric amounts equivalent to the samples shown in FIGS. 1B and 1E, are presented in FIGS. 1C and 1F, respectively. The comparison of these images demonstrates an identical core-shell NCs' diameter when prepared by single-injection or two-injection processes. In addition, the energy dispersive analysis of electron diffraction (EDAX) measurements confirmed the existence of the Pb, Se and S constituents at the indicated core-alloyed shell samples. Thus, these experiments suggest that a single-injection of Pb, Se and S precursors results in the generation of core-alloyed shell structures with crystallography, size, and composition similar to the equivalent NCs prepared by a two-injection process. The faster reactivity of Pb with Se precursors, in comparison with the reaction with the S precursors (Weast, 1980), leads to a faster nucleation of a PbSe core, followed by the formation of a shell containing the PbS reagent, although the formation of a homogenous PbSeₓS₁₋ₓ alloy is known in the literature as a bulk compound (Wei et al., 1997).

### Example 6

### Comparison of the Optical Properties of the NC Samples

We then compared the influence of the shell composition on the optical properties of the samples (a), (b) and (c) described in Example 5. The optical properties of the samples further clarified the nature of the core-shell NCs formed by a single-injection process. The absorption spectra of core PbSe NCs with various diameters (2.3 nm, 3.1 nm, 3.5 nm, 3.7 nm, 4.4 nm, 4.9 nm, 5.4 nm, 5.9 nm, 6.1 nm, 6.3 nm, 6.8 nm, and 7.0 nm), with a measured quantum efficiency of 40%, are shown in FIG. 2. These samples showed an energy blue shift with a decrease in the NCs size, tunable in the near IR spectral regime. As indicated in the Background of the Invention section above, a cubic rock salt PbSe semiconductor exhibits direct band transitions at the L point of the Brillouin zone with a four-fold degeneracy. Ignoring this degeneracy, the allowed transitions obey the Δj=0, ±1 and πₑπₕ=−1 selection rules, when j and π designate the total angular momentum and parity of the electronic state. According to these rules, the lowest absorption band corresponds to the j=½, π=1→j=½, π=−1 transition (indicated herein as 1S-exciton); and the third lowest absorption band corresponds to the j=½ or 3/2, π=−1→j=½ or 3/2, π=1 transition. The parity-forbidden transition j=½, π=1→j=½, 3/2, π=1 or j=½ or 3/2, π=−1→j=½, π=−1 is partially allowed due to a mixing of the degenerate states in the valence band, and those are responsible for the second lowest absorption band.

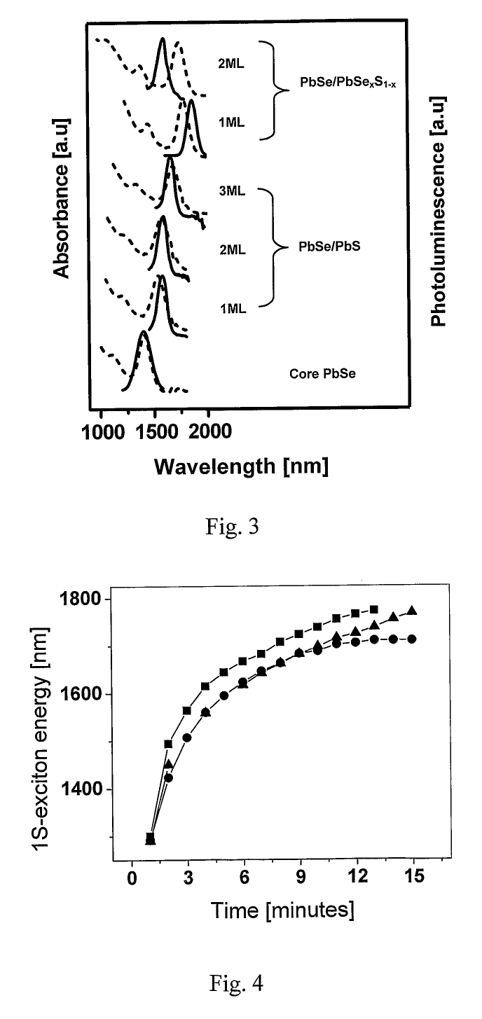

The absorption and photoluminescence (PL) spectra of core PbSe NCs with a diameter of 4.9 nm are shown by the dashed and solid lines, respectively, at the bottom of FIG. 3. The spectra of PbSe/PbS core-shell NCs, prepared by a two-injection process, comprised of a 4.9 nm PbSe core and n-MLs (n=1, 2, 3) of a PbS shell, are presented by the three middle curves in FIG. 3. It is interesting to note that the full width at half maximum (FWHM) of the PbSe/PbS core-shell NCs 1S-emission bands is narrower by a factor ˜2 from that of the PbSe core (see Table 1). Moreover, both absorption and PL bands of the PbSe/PbS core-shell NCs samples are red-shifted (up to 152 meV) with an increase of the PbS shell thickness, as summarized in Table 1. This Table also indicates a luminescence Stokes shifts of −8 to 18 meV in the core PbSe and core-shell PbSe/PbS NCs samples. The absorption and PL spectra of the PbSe/PbSeₓS₁₋ₓ core-alloyed shell NCs, prepared by a single-injection process with stoichiometric amounts equivalent to a 1ML (named PbSe/PbSeₓS₁₋ₓ-1ML) and 2ML (named PbSe/PbSeₓS₁₋ₓ-2ML) of PbS shell, are shown at the two top curves in FIG. 3. The spectra of the PbSe/PbSeₓS₁₋ₓ-2ML sample exhibit a peculiar behavior, including a red-shift of the absorbance 1S-exciton band with respect to that of the PbSe/PbSeₓS₁₋ₓ-1ML sample; and a large (−44 meV) anti-Stokes shift of the PL band (see Table 1). The spectra of the PbSe/PbSeₓS₁₋ₓ-1ML sample exhibit a similar behavior to that described above for simple PbSe/PbS core-shell samples prepared with a two-injection process (see Table 1). Also, it is important to note that the 1S-exciton of the PbSe/PbSeₓS₁₋ₓ-nML (n=1, 2) samples has a quantum efficiency of about 65%, higher compared to that of core PbSe and PbSe/PbS core-shell samples (vide infra).

TABLE 1
Parameters associated with the absorption and PL spectra of the studied NCs

| | | 1S-Exciton | | | | | |
|---|---|---|---|---|---|---|---|
| | | Absorption | 1S-Exciton | Stokes | Absorption | PL | ΔE_{1S} (Abs.) = |
| | Diameter | Energy | PL Energy | Shift | FWHM | FWHM | E_{core-shell} − E_{core} |
| | r (nm)^{[a]} | (eV) | (eV) | (meV) | (meV) | (meV) | (meV)^{[b]} |
| 1 | 4.8 | 0.890 | 0.882 | 8 | 84 | 99 | |
| 2 | 6.1 | 0.804 | 0.786 | 18 | 80 | 52 | 86 |
| 3 | 7.3 | 0.782 | 0.780 | 2 | 87 | 50 | 106 |
| 4 | — | 0.772 | 0.780 | −8 | 72 | 49 | 152 |
| 5 | 6.1 | 0.696 | 0.667 | 29 | 82 | 40 | |
| 6 | 7.5 | 0.732 | 0.776 | −44 | 55 | 54 | |

1—PbSe core; 2—PbSe/PbS 1ML; 3—PbSe/PbS 2ML; 4—PbSe/PbS 3ML; 5—PbSe/PbSeₓS₁₋ₓ 1ML; 6—PbSe/PbSeₓS₁₋ₓ 2ML
^{[a]}As measured by HR-TEM;
^{[b]}ΔE_{1S} (Abs.)—Energy difference between the 1S-exciton absorption bands of PbSe/PbS and PbSe core NCs.

The red shift of the absorbance and PL bands in the PbSe/PbS core-shell samples, with respect to that in a reference core PbSe sample (shown in FIG. 3) can be explained by anomalous sequence of the valence and conduction edge energies, when E_{C}(PbS)>E_{C}(PbSe)>E_{V}(PbS)≧E_{V}(PbSe), as reported in bulk IV-VI compounds (Wei et al., 1997). Thus, a spread of the carrier's wave function over E_{V}(PbSe) and E_{V}(PbS) states might occur, red-shifted with respect to the core transitions. Furthermore, an alloyed formation at the core-shell interface would lead to a tunability of the energy difference ΔE=E_{V}(PbSe)−E_{V}(PbSeₓS₁₋ₓ) states, depending on the alloy composition and thickness. A wave function expansion over the core-shell interface was also mentioned in CdSe/ZnS and InP/TOP NCs, with shell potential barrier that is much larger than that of the PbSe/PbS core-shell samples (Dabbousi et al, 1997; Steckel et al., 2004; Neuhauser et al., 2000; Micic et al., 2000; Millo et al., 2001).

A relatively small PL Stokes shift of various cases in FIG. 3 is associated with a zero-phonon-assisted excitation and emission processes, between j=½, π=1→j=½, π=−1 states, within the PbSe core. However, an anti-Stokes (negative) shift, which accures in NCs with high S concentration, may be involved with excitation between states with a mixing of E_{V}(PbSe) and E_{V}(PbS), pursued by an emission event between band edge states of the PbSe core only. This anti-Stokes process resembles an energy up-conversion, measured previously in colloidal InP and CdSe NCs capped with organic ligands (Pakovich et al., 2002; Maruyama et al., 2001).

### Example 7

### Growth Dynamics of Core-Alloyed Shell NCs

The growth dynamics of core-alloyed shell NCs, prepared by a single-injection process at 120° C., was compared with that of simple core NCs, following the variations in the absorption energy and intensity of aliquots periodically drawn from the reaction solution. A plot of the 1S-exciton energy versus the reaction time is shown in FIG. 4. Each point corresponds to the duration of one minute in the reaction time, while the solid lines are drawn only to guide the eye. The spheres represent core NCs showing a gradual increase of the size (or a red shift of the exciton energy) until a plateau is reached after about thirteen minutes, when at least one of the precursors was consumed. The triangles in FIG. 4 represent the core-shell NCs, prepared with Pb:Se:S molar ratio appropriate for the formation of PbSe core and 1ML PbS shell. This figure reveals that a PbSe core is formed during the first eight minutes; however, a band-edge variation occurs beyond this point due to the generation of a core-shell or core-alloyed shell structure. The squares in FIG. 4 represent core-alloyed shell NCs with Pb:S stiochiometric amounts that are equivalent to 2ML of PbS shell. The 1S-exciton energy of the PbSe/PbSeₓS₁₋ₓ-2ML is red-shifted with respect to the core samples already after the first two minutes, presumably owing to the production of a gradual alloy composition after the initial nucleation of the PbSe core (first point on the graph).

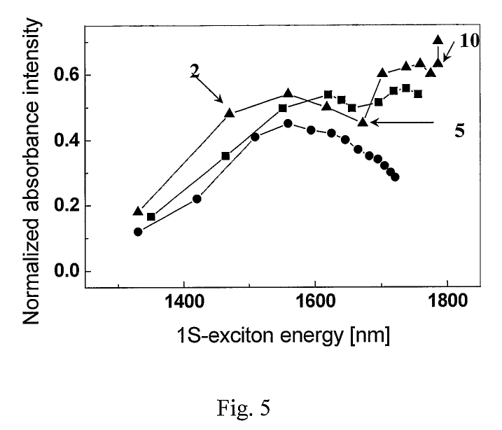

FIG. 5 shows plots of the normalized intensity of the 1S-exciton versus its energy for various aliquots with identical NCs concentrations. The dots represent the 1S-exciton intensity of core PbSe NCs, revealing the creation of NCs with the highest quantum efficiency after about four minutes, when each point represent the duration of a minute in the reaction time (see arrows in FIG. 5). The corresponding emission quantum efficiency, as measured by ellipsometer (not shown) was found to be 40%. The triangles represent the variation of the exciton intensity of PbSe/PbSeₓS₁₋ₓ sample with equivalent molar ratio to 1ML of PbS. This curve reveals a growth parallel to that of simple core NCs, pursued by an abrupt change after about 5 minutes, due to the formation of a shell or alloyed shell.

It is interesting to note that the existence of a shell immediately increased the quantum efficiency of the 1S-exciton to about 65%. The triangles in FIG. 5 indicate that a single-injection process including stoichiometric amounts of 1ML of PbS shell is initiated by the nucleation of a PbSe core, followed by the deposition of the PbSeₓS₁₋ₓ shell. The squares in FIG. 5 represent the growth dynamics of core-alloyed shell NCs, with Pb:S stoichiometric ratio equivalent to 2ML of PbS shell. The shift of this curve with respect to the simple core NCs suggests the generation of an alloy composition, already at an early stage of the NCs' growth, referring to the formation of a PbSe/PbSeₓS₁₋ₓ/PbS structure.

The influence of the shell composition on the band edge properties can be examined by absorption and photoluminescence spectroscopy, to explore whether the core-alloyed shell structures expose a new possibility in tuning the band gap energy not only by the size of the NCs, but also by the chemical composition and shell thickness, with narrower size distribution (5%) and higher quantum efficiency (65%).

### REFERENCES

Andreev A. D., Lipovski A. A., Phys. Rev. B, 1999, 59, 15402.
Colvin V. L., Schlamp M. C., Alivisatos A. P., Nature, 1994, 370, 354.
Dabbousi B. O., Rodriguez-Viejo J., Mikulec F. W., Heine J. R., Mattoussi H., Ober R., Jensen K. F., Bawendi M. G., J. Phys. Chem. 1997, 101, 9463.
Dahan M., Laurence T., Pinaud F., Chemla D. S., Alivisatos A. P., Suer M., Weiss S., Phys. Rev. B, 2001, 6320, 5309.
Du H., Chen C., Krishnan R., Krauss T. D., Harbold J. M., Wise F. W., Thomas M G., Silcox J., Nano Letters, 2002, 2, 1321.
Fradkin L., Langof L., Lifshitz E., Rogach A., Gaponik N., Weller H., Eychmuller A., ChemPhysChem, 2003, 4, 1203.
Klimov V. I., Mikhailovsky A. A., Xu S., Malko A., Hollingsworth J. A., Leatherdatle C. A., Eisler H. J., Bawendi M. G., Science, 2002, 290, 314.
Lifshitz E., Bashouti M., Kloper V., Kigel A., Eisen M. S., Berger S., Nano Letters, 2003, 3, 857.
Micic O. I., Smith B. B., Nozik A. J., J. Phys. Chem. B, 2000, 104, 12149.
Millo O., Katz D., Cao Y. W., Banin U., Phys. Stat. Sol. B, 2001, 224, 271.
Murayama K., Hagiwara Y., Nakata H., Sol. Stat. Comm. 2001, 117, 419.
Murphy C. J., Brauns E. B., Gearheart L., in “Advances in Microcrystalline and Nanocrystalline Semiconductors” Symposium. Mater. Res. Soc., Pittsburgh, Pa., USA 1997, p. 597.
Murray C. B., Shouheng S., Gaschler W., Doyle H., Betley T. A., Kagan C. R., IBMJ Res. & Dev. 2001, 45, 47.
Neuhauser R. G., Shimizu K. T., Woo W. K., Empedocles S. A., Bawendi M. G., Phys. Rev. Lett. 2000, 85, 3301.
Pakovich Y. P., Filonovich S. A., Gomes M. J. M., Donegan J. F., Talapin D. V., Rogach A. L., Eychmuller A., Phys. Stat. Sol. B, 2002, 229, 449.
Santoni A., Paolucci G., Santoro G., Prince K. C., Christensen N. I., J. Phys. Cond. Matt, 1992, 4, 6759.
Sashchiuk A., Amirav L., Bashouti M., Krueger M., Sivan U., Lifshitz E., Nano Letters, 2003, 4, 159.
Sashchiuk A., Langof L., Chaim R., Lifshitz E., J. Cry. Growth, 2002, 240, 431.
Schaller R. D., Petruska M. A., Klimov V. I., J. Phys. Chem. B, 2003, 107, 13765.
Sirota M., Galun E., Krupkin V., Glushko A., Kigel A., Brumer M., Sashchiuk A., Amirav L., Lifshitz E., Proccedings of SPIE, August 2004.
Steckel J. S., Zimmer J. P., Coe-Sullivan S., Stott N. E., Bulovic V., Bawendi M. G., Angew. Chem. Int. Ed. 2004, 43, 2154.
Weast Ed. R. C. “Handbook of Chemistry and Physics”, CRC, 60th edition, 1979-1980, B-220.
Wehrenberg B. L., Wang C., Guyot-Sionnest P., J. Phys. Chem. B, 2002, 106, 10634.
Wei S. H., Zunger A., Phys. Rev. B. 1997, 55, 13605.
Yu W. W., Falkner J. C., Shih B. S., Colvin V. L., Chem. Mater. 2004, 16, 3318.

What is claimed is:

1. A core-alloyed shell semiconductor nanocrystal comprising: (i) a core of a semiconductor material having a selected band gap energy; (ii) a core-overcoating shell consisting of one or more layers comprised of an alloy of the said semiconductor of (i) and a second semiconductor; (iii) and an outer organic ligand layer, provided that the core semiconductor material is not HgTe.

2. The core-alloyed shell semiconductor nanocrystal of claim 1, wherein the band gap energy of the core semiconductor material is in the infra-red energy range.

3. The core-alloyed shell semiconductor nanocrystal of claim 2, wherein said core semiconductor material is PbS, PbSe, PbTe, InN, InP, InAs, InSb, HgS, HgSe, or GaSb.

4. The core-alloyed shell semiconductor nanocrystal of claim 3, wherein said core semiconductor material is PbSe.

5. The core-alloyed shell semiconductor nanocrystal of claim 1, wherein the band gap energy of the core is in the visible energy range.

6. The core-alloyed shell semiconductor nanocrystal of claim 5, wherein said core semiconductor material is CdS, CdSe, CdTe, ZnSe, ZnTe, AlAs, AlP, AlSb, AlN, GaP or GaAs.

7. The core-alloyed shell semiconductor nanocrystal of claim 1, wherein the band gap energy of the core is in the ultraviolet energy range.

8. The core-alloyed shell semiconductor nanocrystal of claim 7, wherein said core semiconductor material is CdS, ZnS or GaN.

9. The core-alloyed shell semiconductor nanocrystal of claim 1, wherein the core has the structure of AB or AC; the semiconductor shell comprises an alloy of the ABₓC₁₋ₓ structure, wherein A is selected from the group consisting of Cd, Zn, Hg, In, Ga, and Pb; B and C are selected from the group consisting of N, P, As, S, Se and Te; x is the mole fraction of B and 1-x is the mole fraction of C, with x gradually changing from 1 to zero.

10. The core-alloyed shell semiconductor nanocrystal of claim 9, wherein the core semiconductor material is PbSe and the alloy shell semiconductor material has the PbSeₓS₁₋ₓ structure.

11. The core-alloyed shell semiconductor nanocrystal of claim 1, wherein the core has the structure of DF or EF; the semiconductor shell comprises an alloy of the DₓE₁₋ₓF structure, wherein D and E, the same or different, are selected from the group consisting of Cd, Zn, Hg, In, Ga, and Pb; F is selected from the group consisting of N, P, As, S, Se and Te; x is the mole fraction of D and 1-x is the mole fraction of E, with x gradually changing from 1 to zero.

12. The core-alloyed shell semiconductor nanocrystal of claim 1, wherein the alloyed shell exhibits gradual change of the crystallographic lattice spacing.

13. The core-alloyed shell semiconductor nanocrystal of claim 1, wherein the alloyed shell exhibits gradual change of the dielectric constant.

14. The core-alloyed shell semiconductor nanocrystal of claim 1, wherein the nanocrystal size is in the range of about 3 nm to about 50 nm, preferably from about 3 nm to about 20 nm, more preferably from about 3 nm to about 20 nm.

15. The core-alloyed shell semiconductor nanocrystal of claim 1, wherein said core alloyed shell semiconductor nanocrystal exhibits less than a 10% root-mean-square (rms) deviation in diameter.

16. The core-alloyed shell semiconductor nanocrystal of claim 1, wherein the nanocrystal exhibits photoluminescence having quantum yields of greater than 20%.

17. A single-injection process for the synthesis of a core-alloyed shell semiconductor nanocrystal of claim 1, comprising the simultaneous injection of stiochiometric amounts of the core and shell semiconductor materials or precursors thereof into a mother solution comprised of the organic ligands or in which mother solution the organic ligands are dissolved, at elevated temperatures, under inert conditions, whereby a fast nucleation of the core superconductor material occurs, followed by a deposition of the semiconductor shell material with a gradual composition.

18. A process according to claim 17 for the preparation of PbSe/PbSeₓS₁₋ₓ nanocrystals comprising injecting a mixture of: (i) the precursor lead acetate trihydrate dissolved in a solution of phenyl ether, oleic acid and trioctylphosphine (TOP) and (ii) a chalcogen precursor mixture of Se and S dissolved in TOP, into a pre-heated phenyl ether mother solution, terminating the nanocrystals growth by quenching to room temperature, and isolating the PbSe/PbSeₓS₁₋ₓ nanocrystals.

19. A nanocrystal array composed of a plurality of core-alloyed shell semiconductor nanocrystals of claim 1, in ordered or disordered packing, with close proximity of the said nanocrystals, reserving the properties of individual nanocrystals and creating new collective effects.
